(19) United States
(12) Patent Application Publication
(10) Pub. No.: US 2009/0097251 A1
(43) Pub. Date: Apr. 16, 2009

(54) LIGHT HOMOGENIZING DEVICE AND DISPLAY APPARATUS INCLUDING THE SAME

(75) Inventors: Anatoliy Lapchuk, Suwon-si (KR); Haeng-Seok Yang, Bucheon-si (KR); Seung-Do An, Suwon-si (KR); Victor Yurlov, Suwon-si (KR); Sang-Kyeong Yun, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/245,652

(22) Filed: Oct. 3, 2008

(30) Foreign Application Priority Data
Oct. 4, 2007 (KR) 10-2007-0099695
Dec. 7, 2007 (KR) 10-2007-0126586

(51) Int. Cl. F21V 33/00; F21V 5/00

(52) U.S. Cl. 362/253; 362/311.01

(57) ABSTRACT

Disclosed are a light homogenizing device and a display apparatus including the same. The light homogenizing device can include a light source; a polarization rotator, including two planes of polarization that are vertical to each other, and receiving a beam of light incident from the light source and outputting a polarized linear beam of light having different polarization depending on driving voltage; and a birefringent plate, receiving the polarized linear beam of light and outputting two refracted beams of light proceeding by being refracted in different directions. Here, the two refracted beams of light can be combined at a predetermined point into a uniform beam of light. With the present invention, the light homogenizing device can improve the uniformity of an image through the decrease of a fringe pattern.

### CROSS-REFERENCE TO RELATED PATENT APPLICATIONS

This application claims the benefit of Korean Patent Application Nos. 10-2007-0099695 and 10-2007-0126586, filed on Sep. 4, 2007 and Dec. 7, 2007, respectively, in the Korean Intellectual Property Office, the disclosure of which is incorporated herein in its entirety by reference.

### BACKGROUND OF THE INVENTION

1. Field of the Invention

The present invention relates to a display an apparatus, more specifically to a display apparatus that can improve the uniformity of an image by homogenizing the variation of light.

2. Background Art

A one-dimensional diffraction type optical modulator, which is used for a scanning display apparatus as one of various types of display apparatuses, is configured to include a plurality of micromirrors arranged in a line in order to output a modulation beam of light corresponding to a linear image. At this time, the micromirror adjusts the quantity of the modulation beam of light by allowing its displacement to be changed corresponding to a driving signal (e.g. a driving voltage). This modulation beam of light is scanned on a screen through a scanner, to thereby display a two-dimensional image.

At this time, a laser beam used for the scanning display apparatus mostly has an elliptical section. However, the form of the section of the laser beam is required to be converted to a form closest to that of the configuration of a one-dimensional pixel array, which is a one-dimensional optical modulator, and the laser beam is required to have the uniform distribution. This is because a beam of light emitted from the light source is incident on the one-dimensional optical modulator and is converted to a modulation beam of light, and the modulation beam of light is used to form a display image, as described above. Here, the form of beam is required to be converted to a one-dimensional pixel arrangement form in order that the beam of light incident on each micromirror constituting the optical modulator can have uniform amount and intensity. This enables the image to have the improve uniformity.

However, since the laser beam actually used as the light source has the very different form as compared with one-dimensional pixel arrangement form, an image formed through the scanning display apparatus cannot avoid having the intensity of light changed between pixels and a fringe pattern. This causes the brightness and color of an image to be changed and the image quality to be lowered.

Also, an incident beam of light incident from a light source to an optical modulator has an important effect on the quality of an image to be displayed later on a screen. In particular, the variation of light in an illumination system including the light source through the optical modulator causes a horizontal line pattern to be finally displayed, to thereby deteriorate the quality of an image to be displayed. In order to solve the problem, the method that a correcting value according to the variation of light is added to a driving signal for the optical modulator has been used.

### SUMMARY OF THE INVENTION

Accordingly, the present invention provides a display apparatus including a light homogenizing device that can enhance the uniformity of an image by reducing fringe patterns.

The present invention also provides a display apparatus that can remove the variation of light in an illumination system and minimize the initial correction of an optical modulator.

An aspect of present invention features a light homogenizing device including a light source; a voltage driving polarization rotator having output beams with two different polarization that are orthogonal to each other, receiving a beam of light incident from the light source and outputting a polarized linear beam of light with polarization direction dependent on driving voltage; and a birefringent plate, receiving the polarized linear beam of light and outputting shifting beam with the beam shift depending on input beam polarization proceeding. The birefringent plate should be leaned to a forwarding direction of the beam of light incident on the birefringent plate at a predetermined angle to get sufficient beam shift for obtaining time intensity averaging. Here, the active polarization rotator switches fast in time the incident laser beam polarization between two orthogonal polarization plane and a birefringent plate makes beam different beam shifts due to different refraction index for different polarization and light intensity can be average in time to create a uniform beam of light.

At this time, the polarization rotator can be a liquid crystal polarization rotator, and the liquid crystal polarization rotator can output the polarized linear beam of light with two orthogonal plane of polarization by changing an optical-active characteristic according to a supplied power. The uniform beam of light is results of averaging of two shifted beams and therefore a normalized standard deviation of the uniform beam of light can be decrease at square root of two of a normalized standard deviation of one refracted beam of light.

Another aspect of present invention features a display apparatus including a light source; an active polarization rotator, having output linear polarized beams with two planes of polarization that are orthogonal to each other, and receiving a beam of light incident from the light source and outputting a polarized linear beam of light; a birefringent plate, receiving the polarized linear beam of light and outputting in different time interval two refracted beams of light proceeding by being refracted in different directions, a one-dimensional optical modulator, arranged at a point on which the two refracted beams of light are combined into a predetermined point, and receiving the uniform beam of light and outputting a modulation beam of light; and a scanner, successively scanning the modulation beam of light on a display screen.

At this time, the polarization rotator can be a liquid crystal polarization rotator, and the liquid crystal polarization rotator can output the different polarized linear beam of light by changing an optical-active characteristic according to a supplied power. The birefringent plate should be leaned to a forwarding direction of the beam of light incident on the birefringent plate at a predetermined angle to get sufficient beam shift for obtaining time intensity averaging. The uniform beam of light is a results of averaging of two shifted beams and therefore a standard deviation of light intensity of the uniform beam of light can be decrease at square root of two of a standard deviation of light intensity of one refracted beam of light.

If the modulation beam of light is successively scanned to form a two-dimensional image, the predetermined interval of time can be the same as or smaller than an interval of time it takes for a frame to be formed, and the modulated beam of light can be successively scanned on a screen to form a two-dimensional image. A size of the uniform beam of light can correspond to the size and number of micromirrors arranged in a lengthwise direction of the one-dimensional optical modulator.

Another aspect of present invention features a light source; a light homogenizing device, repeatedly changing a proceeding path of a basic beam of light emitted from the light source according to a change of time; an optical modulator, receiving the beam having the changed proceeding path and modulating the received beam of light to output a modulation beam of light; a scanner, scanning the modulation beam of light outputted from the optical modulator on a screen; and an image processing unit, receiving an image signal and generating and outputting a control signal for controlling the light source, the optical modulator and the scanner according to the image signal.

The optical modulator can be a linear optical modulator in which a plurality of micromirrors are arranged in a line.

A sectional surface of the basic beam can include all incident surfaces of the optical modulator. The light homogenizing device can allow one end part of a sectional surface of the basic beam to be in contact with one end part of the optical modulator at a first point of time and the other end part of a sectional surface of the basic beam to be in contact with the other end part of the optical modulator at a second point of time. The light homogenizing device can also change a proceeding path of the basic beam of light in a range between a proceeding path of the first point of time and a proceeding path of the second point of time. Finally, the light homogenizing device can change a proceeding path of the basic beam proceeding from the first point of time to the second point of time or from the second point of time to the first point of time within a period of time that it takes for the optical modulator to output a modulation beam corresponding to one linear image.

The light homogenizing device can be made of an electro-optical material.

The light homogenizing device can include a light transmissive unit and a vibrator, connected to one end part of the light transmissive unit and vibrating the light transmissive unit.

### BRIEF DESCRIPTION OF THE DRAWINGS

These and other features, aspects and advantages of the present invention will become better understood with regard to the following description, appended Claims and accompanying drawings where:

FIG. 1 illustrates a display apparatus in accordance with an embodiment of the present invention;

FIG. 2 shows the shape of a micromirror constituting an optical modulator included in a display apparatus in accordance with an embodiment of the present invention;

FIG. 3 is a plan view showing the optical modulator including the plurality of micromirrors of FIG. 2;

FIG. 4A and FIG. 4B illustrate the structure of an illumination system including a light homogenizing device in accordance with an embodiment of the present invention;

FIG. 5 illustrates the structure of an illumination system including a light homogenizing device in accordance with another embodiment of the present invention;

FIG. 6A and FIG. 6B are graphs showing a uniform beam and a refracted beam having a regular fringe pattern in accordance with an embodiment of the present invention; and

FIG. 7A and FIG. 7B are graphs showing a uniform beam and a refracted beam having a irregular fringe pattern in accordance with an embodiment of the present invention.

FIG. 8 shows a basic beam of light emitted from a light source;

FIG. 9 shows how a display apparatus including a light homogenizing device uniforms light properties in accordance with an embodiment of the present invention;

FIG. 10 shows how a display apparatus including a light homogenizing device uniforms light properties in accordance with an embodiment of the present invention; and

FIG. 11 shows an area of a basic beam of light incident on an optical modulator according to a time.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Even through the below description is mainly related to the case using a display apparatus including a light homogenizing device and an optical modulator, the light homogenizing device of the present invention can be applied to any device using a scanned one-dimensional image as well as an optical modulator.

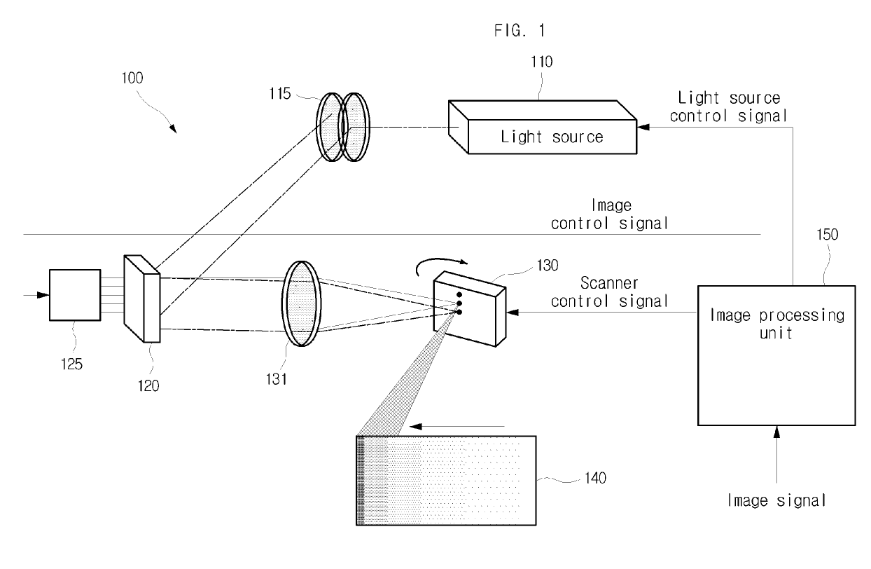

Hereinafter, the display apparatus including a light homogenizing device in accordance with an embodiment of the present invention will be described with reference to FIG. 1. FIG. 1 illustrates a display apparatus in accordance with an embodiment of the present invention.

Referring to FIG. 1, the display apparatus 100 in accordance with an embodiment of the present invention can include a light source 110, a light homogenizing device 120, an optical modulator 130, a light projecting unit 140, a scanner 150 and a screen 160.

The light source 110 can be a laser source, which employs a semiconductor laser, a solid gas laser or a liquid laser. The laser source is not limited to a specific laser type.

A beam of light emitted from the light source 110 can pass through the light homogenizing device 120 before being incident on the optical modulator 130. At this time, if the beam of light emitted from the light source 110 forms an image, the light homogenizing device 120 can enhance the uniformity of the image. This will be described later.

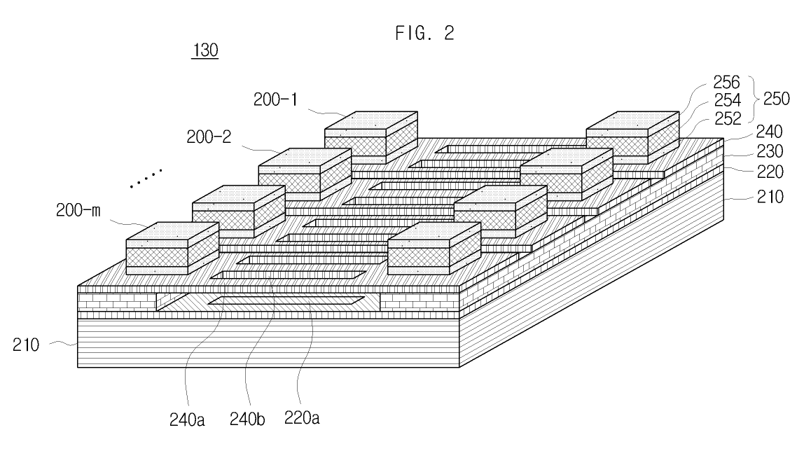

The optical modulator 130 can include a plurality of micromirrors. The micromirrors can be arranged in a line. In other words, the micromirrors can correspond to each pixel of an image displayed on the screen, and the plurality of micromirrors arranged in a line form can constitute the optical modulator 130. For example, the structure of an optical modulator including upper and lower reflection layers modulating beams of light will be described later with reference to FIG. 2.

Point beams of light are not inputted into the micromirrors constituting the optical modulator 130 in units of pixels. Instead, inputting linear beams of light into the optical modulator 130 having a line shape by a time-division method makes it possible to allow each of the micromirrors to modulate the beams of light and the optical modulator 130 including the plurality of micromirrors to output a modulated one-dimensional linear beam of light. Finally, a modulation beam of light outputted from the whole part of the optical modulator 130 can be represented as one linear scanning line on the screen 160. The scanning can be successively performed on the screen 160, to thereby form a complete two-dimensional planar image.

The beam of light modulated by the optical modulator 130 can pass through the light projecting unit 140 before being inputted into the scanner 150. The scanner 150 can scan the linear beam of light in a direction in order to form a planar image. In particular, the scanner 150 can reflect the modulated linear beam of light incident from the optical modulator 130 at a predetermined angle before projecting the reflected linear beam of light on the screen 160. For example, the linear beam of light outputted from the vertically directional optical modulator 130 can be scanned in a horizontal direction of the screen 160, to thereby complete a two-dimensional planar image.

Here, the predetermined angle can be determined by a scanner control signal inputted from an image processing unit (not shown). The scanner control signal can be synchronized with an image control signal and allow the scanner 150 to be rotated at an angle. At this time, the modulated beam of light can be projected on the position of a vertical line (or a horizontal line) on the screen 160 corresponding to the scanner control signal at the angle. In particular, the scanner control signal can include information related to a driving speed and a driving angle. The scanner 150 can be placed on a position on the screen 160 at a time according to the driving angle and speed. The scanner 150 can be a polygon mirror, a rotating bar, or a Galvano mirror, for example.

The light source 110, the optical modulator 130 and the scanner 150 can be controlled by the image processing unit, which is not shown in FIG. 1. In particular, the image processing unit 150 can include a microprocessor. The image processing unit 150 can also be electrically connected to each element of the display apparatus in order to output a signal for controlling the elements. As described above, the image processing unit 150 can control the scanning of the one-dimensional image outputted from the optical modulator 130, performed from a left side to a right side by the scanner 150, by transferring the scanner control signal to the scanner 150. Further, the image processing unit can control each micromirror included in the optical modulator 130 by allowing the micromirror position to be changed corresponding to an image signal in order to generate a one-dimensional image having a desired luminance.

In the display apparatus in accordance with an embodiment of the present invention, the light homogenizing device 120 and the optical modulator 130 can be referred to as an illumination system, and the light projection unit 140, the scanner 150 and the screen 160 can be referred to as a projection system for the convenience of understanding and description of the present invention.

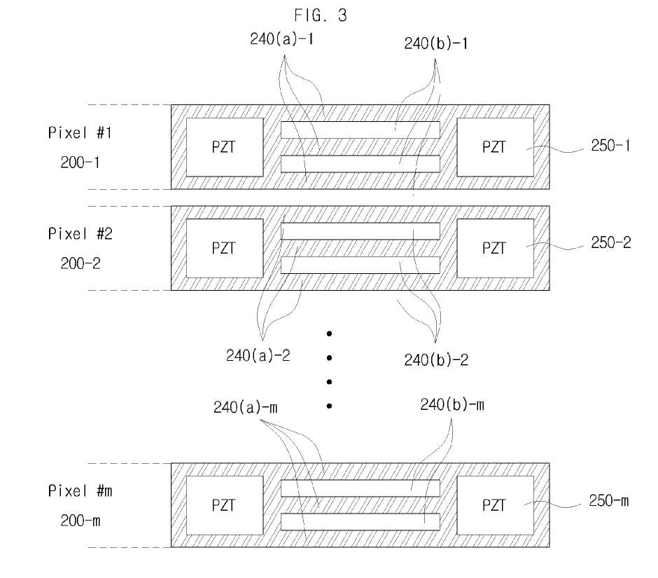

Hereinafter, the structure of an optical modulator included in a display apparatus in accordance with an embodiment of the present invention will be described with reference to FIG. 2 and FIG. 3. FIG. 2 shows the shape of a micromirror constituting an optical modulator included in a display apparatus in accordance with an embodiment of the present invention.

Below is described the optical modulator 130 applicable to the present invention. The optical modulator 130 can modulate a beam of light by a type, which controls the on/off state of the beam of light, and a type, which uses reflection/diffraction. The type using reflection/diffraction can be further divided into an electrostatic type and a piezoelectric type. Although the below description is mainly related to the piezoelectric type, the same can apply to the electrostatic type.

A micromirror included in the optical modulator 130 of open hole structure is illustrated in FIG. 2 and FIG. 3. FIG. 2 is a 3-D perspective view showing the optical modulator 130 including a plurality of micromirrors, and FIG. 3 is a plan view showing the optical modulator 130 including the plurality of micromirrors of FIG. 2. In the embodiments of the present invention, one micromirror is assumed to deal with one pixel.

The optical modulator 130 can be configured to include m micromirrors 200-1, 200-2, . . . and 200-m (hereinafter, collectively referred to as 200), m being a natural number. Each micromirror 200 can include a substrate 210, an insulation layer 220, a sacrificial layer 230, a ribbon structure 240 and a piezoelectric element 250.

The insulation layer 220 can be stacked on the substrate 210. The sacrificial layer 230 can be placed to allow the ribbon structure 240 to be spaced by a gap from the insulation layer 220. The ribbon structure 240 creates diffraction and interference in an incident beam of light to perform the optical modulation of signals. The ribbon structure 240 can include a plurality of open holes 240(b) in a center area.

Here, the open hole 240b is illustrated to have a long rectangular shape in a lengthwise direction of the micromirror 200. The open hole 240b, however, can have various shapes such as a circle and an ellipse. A plurality of open holes 240b having a long rectangular shapes in a widthwise direction of the micromirror 200 can be arranged in parallel.

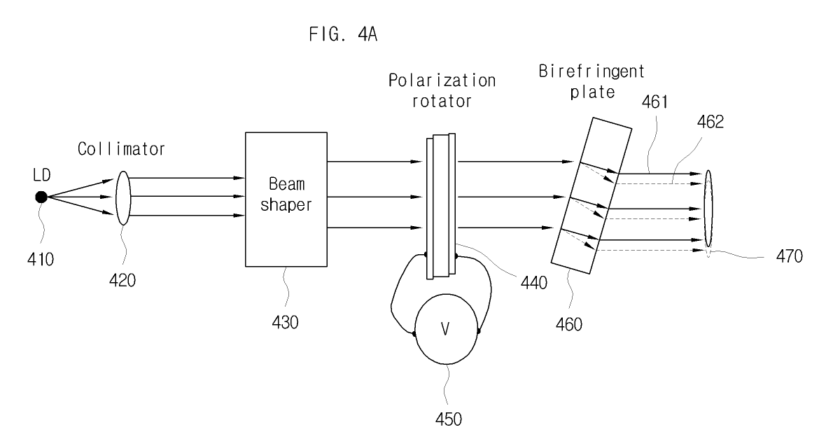

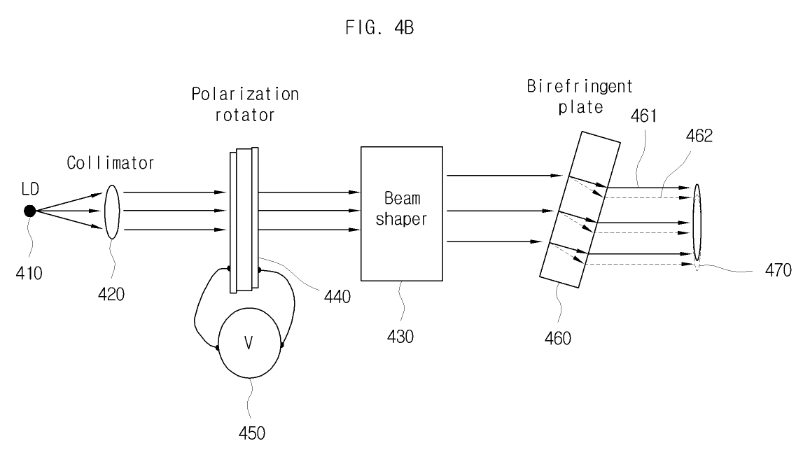

As illustrated in FIG. 2, since the plurality of micromirrors constituting the optical modulator 130 are arranged in a line, as described above, a beam of light incident on the optical modulator 130 may be required to be converted to a linear beam of light. At this time, a beam generator can be used to convert the beam of light incident on the optical modulator 130 to the linear beam of light. This will be described later with reference to FIG. 4.

Also, the piezoelectric element 250, which includes a lower electrode 252, a piezoelectric layer 254 and an upper electrode 256, can control the ribbon structure 240 to move upwardly and downwardly according to upward and downward, or leftward and rightward contraction or expansion levels generated by the difference in voltage between the upper and lower electrodes 252 and 256. Here, a lower reflective layer 220(a) is formed in correspondence with the holes 240(b) formed in the ribbon structure 240 or in the whole part of the insulation layer 220.

For example, in case that the wavelength of a beam of light is λ, a first voltage is supplied to the piezoelectric elements 250. At this time, the first voltage allows the gap between an upper reflective layer 240a, formed on the ribbon structure 240, and the lower reflective layer 220a, formed on the insulation layer 220, to be equal to (2 l)λ/4, l being a natural number. In the case of a 0^{th}-order diffracted beam of light, the overall path length difference between the light reflected by the upper reflective layer 240a and the light reflected by the lower reflective layer 220a is equal to lλ, so that constructive interference occurs and the modulated light renders its maximum luminance (i.e. the maximum quantity of light). In the case of +1^{st} or −1^{st} order diffracted light, however, the luminance of the light is at its minimum luminance (i.e. the minimum quantity of light) due to destructive interference.

Also, a second voltage is supplied to the piezoelectric elements 250. At this time, the second voltage allows the gap between an upper reflective layer 240a formed on the ribbon structure 240, and the lower reflective layer 220a, formed on the insulation layer 220, to be equal to (2 l+1)λ/4, j being a natural number. In the case of a 0^{th}-order diffracted beam of light, the overall path length difference between the light reflected by the upper reflective layer 240a formed on the ribbon structure 240 and the light reflected by the insulation layer 220 is equal to (2 l+1)λ/2, so that destructive interference occurs, and the modulated light renders its minimum luminance (i.e. the minimum quantity of light). In the case of +1^{st} or −1^{st} order diffracted light, however, the luminance of the light is at its maximum luminance (i.e. the maximum quantity of light) due to constructive interference.

As a result of such interference, the micromirror can load a signal for one pixel on the beam of light by adjusting the quantity of the diffracted light. Although the foregoing describes the cases in which the gap between the ribbon structure 240 and the insulation layer 220 is (2 l)λ/4 or (2 l+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light. A 0^{th}, +n^{st} or −n^{st} order diffracted light, n being a natural number, can correspond to a modulated beam of light.

The optical modulator 130 is configured to include m micro-mirrors 200-1, 200-2, . . . , and 200-m, each of which corresponds to a first pixel (pixel #1), a second pixel (pixel #2), . . . , and an m^{th} pixel (pixel #m), respectively, m being a natural number. The optical modulator 130 deals with image information related to one-dimensional images of vertical scanning lines (which are assumed to include m pixels), while each micromirror 200 deals with one pixel among the m pixels constituting the vertical scanning line. Thus, the light reflected or diffracted by each micro-mirror is later projected as a 2 or 3-dimensional image on a screen by the scanner 150.

As illustrated in FIG. 2 and FIG. 3, although the above description is mainly related to the optical modulator of open hole structure in which one micromirror deals with one pixel, a plurality of micromirrors may alternatively deal with one pixel. Also, the micromirrors can be equipped with no open hole and can use the difference in the paths of a reflected beam of light according to the height gap between odd numbered mirrors and even numbered mirrors. It shall be understood by any persons those of ordinary skill in the art that the optical modulators in various different ways can be applied to the present invention.

Hereinafter, the structure of an illumination system included in a display apparatus including a light homogenizing device in accordance with an embodiment of the present invention will be described with reference to FIG. 4A and FIG. 4b. FIG. 4A and FIG. 4B illustrate the structure of an illumination system including a light homogenizing device in accordance with an embodiment of the present invention.

Referring to FIG. 4A and FIG. 4B, the illumination system 400 in accordance with an embodiment of the present invention can include a light source (e.g. a laser diode (LD)) 410, a collimator 420, a beam shaper 430, a polarization rotator 440, a power source 450, a birefringent plate 460 and an optical modulator 470.

A beam of light can be emitted from the light source 410, which employs a semiconductor laser, a solid gas laser or a liquid laser, as described above. The light source 410 is not limited to a specific laser type.

The beam of light emitted from the light source 410 can proceed in parallel by passing through the collimator 420. The collimator 420 can adjust a divergence level of a beam of light emitted from the light source 410. Specifically, in case that the light source 410 is a laser diode, since the beam of light has a great divergence level, it is requires to collimate a diverged beam of light and to meet its focus point in order to adjust the divergence level.

Referring to FIG. 4A, in the display apparatus in accordance with an embodiment of the present invention, a point beam of light emitted in parallel by passing through the collimator 420 can be converted a linear beam of light through the beam shaper 430 before being incident on the optical modulator 470 later. The beam shaper 430 can change the form of the beam of light incident on the optical modulator 470 in order to improve the uniformity of an image. Here, the image is completed by the beam shaper 430, the polarization rotator 440 and the birefringent plate 460.

The linear beam of light converted through the beam shaper 430 can be incident on the polarization rotator 440. The beam of light, which has passed through the polarization rotator 440, can be converted to a polarized linear beam of light. Herein, the polarization rotator 440 can have two planes of polarization that are perpendicularly with each other.

Referring to FIG. 4B, it is recognized that the beam shaper 430 can be placed between the polarization rotator 440 and the birefringent plate 460, unlike the display apparatus of FIG. 4A. As such, the beam shaper 430 can convert a point beam of light to a linear beam of light regardless of its position. In other words, the beam shaper 430 can placed between the polarization rotator 440 and the collimator 420 or between the polarization rotator 440 and the birefringent plate 460 in order to convert a point beam of light to a linear beam of light before being incident on the birefringent plate 460.

In accordance with an embodiment of the present invention, the polarization rotator can be a liquid crystal polarization rotator. In the case of the liquid crystal polarization rotator, the photo-active characteristic can be changed according to a supplied power. Polarized beams of light, which are orthogonal to each other, can be outputted according to the change of the photo-active characteristic. In particular, the power source 450 can supply a power to the liquid crystal polarization rotator, and the photo-active characteristic of the liquid crystal polarization rotator can be changed according to the supplied power. Then, a polarized linear beam of light can be outputted according to the photo-active characteristic.

The polarized linear beam of light outputted from the polarization rotator 440 can be incident on the birefringent plate 460. The polarized linear beam of light incident on the birefringent plate 460 can be refracted corresponding to the plane of polarization of the polarized linear beam of light before proceeding. At this time, the beam of light proceeding through the birefringent plate 460 can be referred to as a refracted beam of light for the convenience of understanding and description.

The polarized linear beam of light incident on the birefringent plate 460 can be double-refracted in order to be divided into two refracted beams of light. The birefringence indicates that a beam of light on a kind of material is double-refracted before being divided into two refracted beams of light having different directions. This may occur because the polarized linear beams of light incident on the birefringent plate 460 have speeds that are varied depending on their polarization directions.

Referring to FIG. 4A and FIG. 4B, the beam of light passed through the birefringent plate 460 can be divided into two refracted beams of light 461 and 462 before proceeding. At this time, the optical axis of the birefringent plate 460 can be in parallel with any one of two planes of polarization of the polarized linear beam of light. The other plane of polarization, which is not in parallel with the optical axis, can be perpendicular with the optical axis. This shows that the two refracted beams of light 461 and 462 proceeding by being double-refracted can have the shifts difference, which is approximately identical to a half of perod of the fringe pattern of illumination system.

At this time, the birefringent plate 460 can lean to the forwarding direction of the beam of light incident on the birefringent plate 460 at a predetermined angle. In other words, the birefringent plate 460 can be rotated at a predetermined angle with respect to the optical axis of the optical modulator 470. As such, the birefringent plate 460 can lean to the forwarding direction of the beam of light incident on the birefringent plate 460 at a predetermined angle, to thereby allow the beam of light incident on the birefringent plate 460 to be divided into two refracted beams of light 461 and 462.

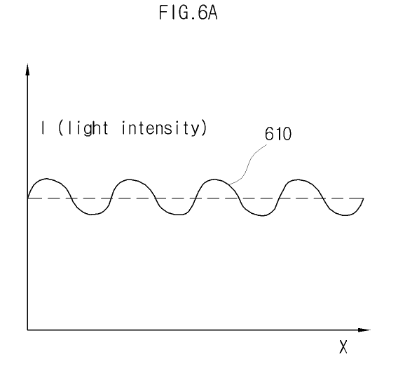

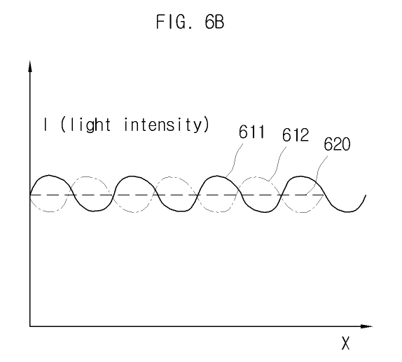

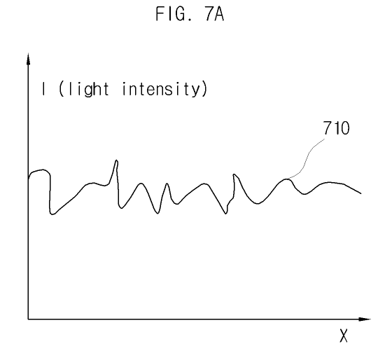

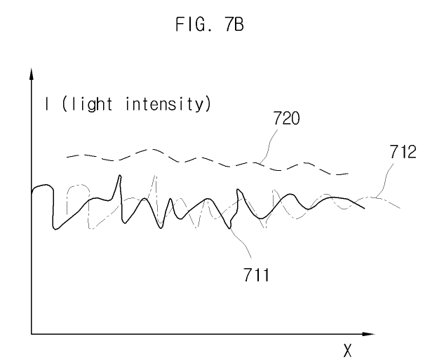

The two divided refracted beams of light 461 and 462 can be combined at a predetermined point to form a uniform beam of light. Hereinafter, the uniform beam of light has the same meaning as described above for the convenience of understanding and description. The uniform beam of light can have the same light intensity as the sum of the intensities of the two refracted beam of light. In other words, since the two refracted beams of light have different shifts but the same intensities, the uniform beam of light can have the double intensity as much as the refracted beam of light. The relationship between the uniform beam and the refracted beam of light will be described with reference to FIG. 6 and FIG. 7.

As described above, the refracted beams of light proceeding through the birefringent plate 460 can have different proceeding speeds. The two refracted beams of light proceeding by being double-refracted can be combined at a predetermined point within a predetermined interval of time to form time averaging uniform beam of light. In accordance with an embodiment of the present invention, the light homogenizing device can include the birefringent plate 460 and the polarization rotator 440.

The uniform beam of light incident on the optical modulator 470 can be modulated later in order to form an image on a screen. At this time, the period of the uniform beam of light can correspond to the size and number of micromirrors arranged in a lengthwise direction. The uniform beam of light incident on the optical modulator 470 can be converted to a modulation beam of light before being outputted. Later, the modulation beam of light can be successively scanned on the screen to form a two-dimensional image.

At this time, the above-described predetermined interval of time it takes for the refracted beam of light to be combined can be smaller than an interval of time it takes for one frame to be formed, in case that the outputted modulation beam of light is successively scanned to form the two-dimensional image. This is because the refracted beam of light may be required to be combined within the interval of time it takes for one frame to be formed in order to allow the uniform beam of light to form a frame, which enables the uniformity of a corresponding image to be improved.

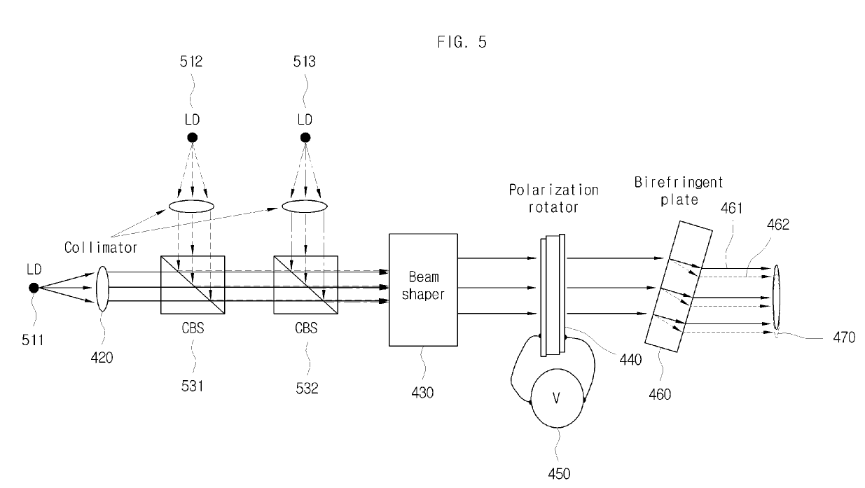

Hereinafter, the structure of an illumination system included in a display apparatus including a light homogenizing device in accordance with another embodiment of the present invention will be described with reference to FIG. 5. FIG. 5 illustrates the structure of an illumination system including a light homogenizing device in accordance with another embodiment of the present invention. Since the illumination system in accordance with another embodiment of the present invention can have the similar configuration to the illumination system of FIG. 4A and FIG. 4B in accordance with an embodiment of the present invention, the pertinent overlapped description will be omitted for the convenience of understanding and description.

Referring to FIG. 5, the illumination system 500 in accordance with another embodiment of the present invention can include light sources 511, 512 and 513, collimators 521, 522 and 523, cubic beam splitters 531 and 532, the beam shaper 430, the polarization rotator 440, the power source 450, the light homogenizing device 460 and the optical modulator 470.

Beams of light can be emitted from each of the light sources 511, 512 and 513. Like the illumination system in accordance with an embodiment of the present invention, the light sources 511, 512 and 513 can be laser diodes (LD). One of big differences in the structures of two illumination systems in accordance with an embodiment and another embodiment of the present invention is 3 light sources.

The light sources 511, 512 and 513 can be a red light source 511, a green light source 512 and a blue light source 513. At this time, the beam of light outputted from 3 light sources 511, 512 and 513 can be linearly polarized. The planes of polarization of each outputted beam of light can be vertical or horizontal.

The beams of light outputted from the light sources 511, 512 and 513 can pass through the collimators 521, 522 and 523, respectively, arranged per each light source 511, 512 and 513, before proceeding in parallel with each other. The beams of light proceeding in parallel with each other can be combined into one beam of light by the cubic beam splitters 531 and 532. In other words, the beams of light emitted from the three color light sources can be combined into one beam of light by the cubic beam splitters 531 and 532.

One beam of light combined by the cubic beam splitters 531 and 532, when being incident on the optical modulator 470, can have its form changed by the beam shaper 430. The beam of light having its form changed by the beam shaper 430 can pass through the polarization rotator 440 and the birefringent rotator 460 to form a uniform beam of light. The uniform beam of light can be incident on the optical modulator 470 later before forming a corresponding image. At this time, it shall be obvious that the beam shaper 430 can be arranged between the cubic beam splitters 531 and 532 and the polarization rotator 440 as described in FIG. 5 or between the polarization rotator 440 and the birefringent plate 460 as described in FIG. 4B.

The above-described operations make it to improve the uniformity of an image formed later on a screen. Since the method of forming the uniform beam of light through the polarization rotator 440 and the birefringent plate 460 has been described with reference to FIG. 4, the pertinent overlapped description will be omitted.

Hereinafter, the method of forming a uniform beam of light by an optical homogenizing device in accordance with an embodiment of the present invention will be described with reference to FIG. 6A and FIG. 7B. FIG. 6A and FIG. 6B are graphs showing a uniform beam and a refracted beam having a regular fringe pattern in accordance with an embodiment of the present invention, and FIG. 7A and FIG. 7B are graphs showing a uniform beam and a refracted beam having a irregular fringe pattern in accordance with an embodiment of the present invention.

FIG. 6A is a graph showing the intensity of a modulated beam 610 of light in accordance with an embodiment of the present invention. The graph shows the intensity of one refracted beam 610 of light outputted from a birefringent plate when a beam of light emitted from a light source is incident on the birefringent plate through a polarization rotator. Referring to the graph, it can be recognized that the refracted beam of light has the intensity close of regular period and the intensity is regularly changed.

FIG. 6B is graphs showing each refracted beam 611 and 612 passed through the birefringent plate in accordance with an embodiment of the present invention. As described above, refracted beams of light, double-refracted when a polarized linear beam of light outputted through the polarization rotator is incident on the birefringent plate, have the shift difference in about half period of a fringe pattern with each other. This can be easily recognized through the graphs showing the intrensity of the refracted beams 611 and 612 of light.

The refracted beams 611 and 612 passed through the birefringent plate can be combined at a predetermined point into one uniform beam of light 620. At this time, the graph showing the intensity of the uniform beam of light 620 is also illustrated in FIG. 6B. Referring to the graph, it can be recognized that the uniform beam of light 620 has the improved intensity uniformity as compared with the refracted beams of light 611 and 612.

At this time, the average intensity of the uniform beam of light can be twice as much as that of one refracted beam of the two refracted beams of light, and a standard deviation of the uniform beam can be close to zero.

Since the same description can be applied to the case that one refracted beam has an irregular fringe pattern, the pertinent overlapped description will be omitted for the convenience of understanding and description.

FIG. 7A is a graph showing the intensity of one refracted beam of light 710 passed through a birefringent plate. The graph shows the intensity of one refracted beam 710 of light outputted from a birefringent plate when a beam of light emitted from a light source is incident on the birefringent plate through a polarization rotator. Referring to the graph, it can be recognized that the refracted beam of light has the intensity of irregular period and the intensity is irregularly changed.

FIG. 7B is graphs showing each refracted beam 711 and 712 passed through the birefringent plate. The refracted beams of light 711 and 712 have the shift difference along beam on birefringence plate in about half period of a fringe pattern with each other. As described above, the refracted beams of light 711 and 712 can be combined in time into one uniform beam of light 720. Referring to the graph showing the intensity of the uniform beam of light 720, can be recognized that the uniform beam of light 720 has the improved intensity uniformity as compared with the refracted beams of light 711 and 712.

At this time, the average intensity of the uniform beam of light, as described above, can be twice as much as that of one refracted beam of the two refracted beams of light, and a standard deviation of the uniform beam can have the square root of sum of square of a sum of a standard deviation of each refracted beam of the two refracted beams and hence the normalized standard deviation of time averaging uniform beam can decrease in square root of 2.

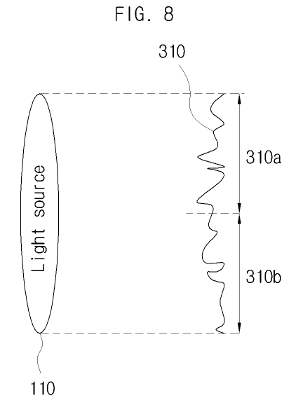

FIG. 8 shows a beam of light emitted from a light source.

A basic beam of light emitted from the light source 110 can undergo an illumination system to have a line shape. This is because each micromirror arranged in a line can load any one scanning line (i.e. horizontal or vertical scanning line) of a displayed screen (i.e. two or three-dimensional image) at a point of time, which is image information related to a linear image, in an optical modulator module as described with reference to FIG. 2 through FIG. 3)

The line-shaped basic beam 310 may have variable light property such as intensity per area. If an area on which the basic beam is projected is largely divided into a first area 310a and a second area 310b, the finally-displayed image may be applied with the light properties of the first area 310a and a second area 310b as they are, to thereby lower the image quality. Accordingly, the illustration system can include a light homogenizing device in order to minimize image quality deterioration and to represent uniform light property through the equalization of a whole displayed image.

Hereinafter, the method of solving the variation of light in an illustration system 700 including the light source 110 through the optical modulator 130 by using the equalization will be described.

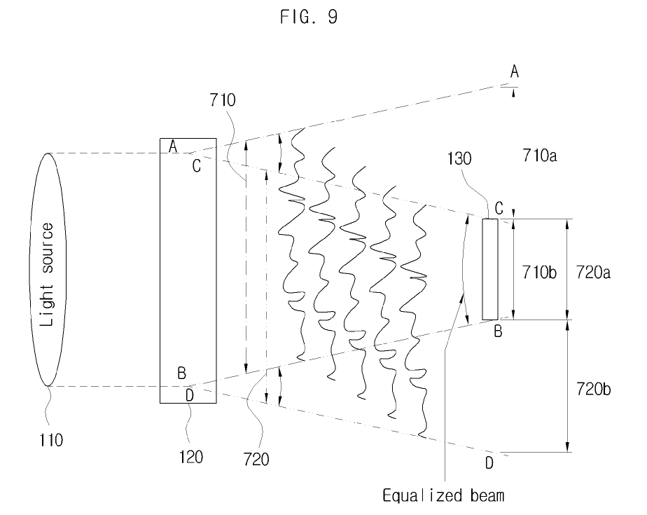

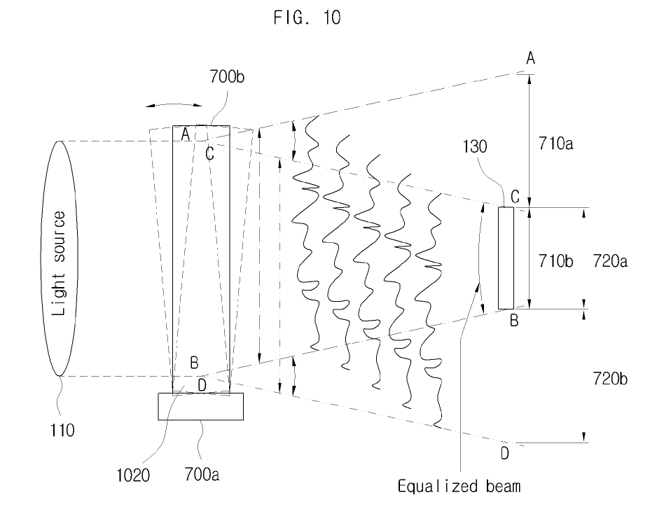

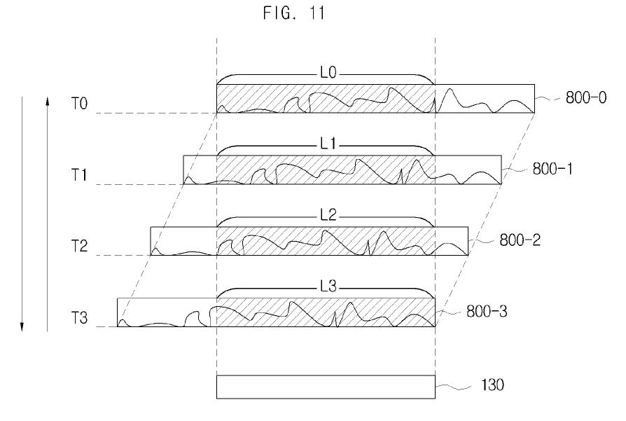

FIG. 9 shows how a display apparatus including a light homogenizing device uniforms light properties in accordance with an embodiment of the present invention, and FIG. 10 shows how a display apparatus including a light homogenizing device uniforms light properties in accordance with an embodiment of the present invention. FIG. 11 shows an area of a basic beam of light incident on an optical modulator according to a time.

In the present invention, a basic beam of light emitted from the light source 110 is assumed to have the longer length than the optical modulator 130. In accordance with an embodiment of the present invention, the basic beam of light emitted from the light source 110 can pass through a light homogenizing device 120 before reaching to the optical modulator 130.

The light homogenizing device 120, which is made of a light-transmissive material, can change the proceeding path of the basic beam emitted from the light source 110. Since a sectional surface of the basic beam is large enough to include an incident surface of the optical modulator 130, although the proceeding path of the basic beam is changed at a predetermined angle, the optical modulator 130 can receive a beam from the light source 110.

At a first point of time, a beam 710 of light, which has passed the light homogenizing device 120, can proceed through the space between AA′ and BB′. In this case, some beam 710b of the beam 710 can be incident on the optical modulator 130. The remaining beam 710a may not be incident on the optical modulator 130. Similarly, at a second point of time, a beam 720 of light, which has passed the light homogenizing device 120, can proceed on the space between CC′ and DD′. In this case, some beam 720a of the beam 720 can be incident on the optical modulator 130. The remaining beam 710b may not be incident on the optical modulator 130.

The light homogenizing device 120 can allow some of a beam of a point of time to be incident on the optical modulator 130 while the beam of a point of time is proceeding through the space which the beam 710 of the first point of time and the beam 720 of the second point of time are proceeding through.

No beams having the same area may be continually incident on each micromirror of the optical modulator 130. Instead, beams having different areas according to the change of time may be incident on each micromirror. Accordingly, although variable basic beams are incident, each micromirror can receive the time-equalized beams, to thereby to have the effect as if the variation of a beam having a certain area is removed.

The light homogenizing device 120 can be made of an electro-optical material. The electro-optical material can change the proceeding path of a basic beam emitted from the light source 110 by adjusting the refractive index according to a supplied signal (e.g. a voltage and a current).

Referring to FIG. 10, in accordance with another embodiment of the present invention, the light homogenizing device 1020 can include a vibrator 700a and a light-transmissive unit 700b. The light transmissive unit, which is made of a light transmissive material, can have a side part connected to the vibration 700a. Accordingly, the light transmissive unit 700b can be vibrated according to the vibration of the vibrator 700a. Also, the vibration of the vibrator 700a can cause an incident angle of the basic beam on the light homogenizing device 120 to be changed. This can lead to the change of an emitting angle, to thereby vary the proceeding path of the basic beam.

FIG. 11 shows how beams incident on an optical modulator by a light homogenizing device are arranged according to the change of time in accordance with the present invention.

In a first point of time T0, the part having some area L0 of a beam 800-0 which has undergone the light homogenizing device 120 can be incident on the optical modulator 130. In other words, one end part of the beam 800-0 can be in contact with one end part of the optical modulator 130. In a second point of time T1, the part having some area L1 of a beam 800-1 which has undergone the light homogenizing device 120 can be incident on the optical modulator 130. In a first point of time T2, the part having some area L2 of a beam 800-2 which has undergone the light homogenizing device 120 can be incident on the optical modulator 130. In a first point of time T3, the part having some area L3 of a beam 800-3 which has undergone the light homogenizing device 120 can be incident on the optical modulator 130. In this case, the other end part of the beam 800-0 can be in contact with the other end part of the optical modulator 130.

As the time proceeds in the order of T0, T1, T2 and T3, the beams having various areas can be incident on the optical modulator 130. Then, in the order of T3, T2, T1 and T0, the beams having various areas can be incident on the optical modulator 130. Repeating the above steps makes it possible to allow equalized uniform beam to be incident on the optical modulator 130.

In other words, the beams having different areas per each point of time can be incident on the optical modulator 130. Even though variable beams are incident on each micromirror of the optical modulator 130 per each point of time, in the case of grouping the time T0 through T3, the variations of each beam incident on the optical modulator 130 can be equalized, which causes the effect as if a uniform beam is incident on the optical modulator 130.

In the meantime, it is assumed that an image finally displayed by the display apparatus of the present invention has n×m pixels, n and m, respectively, being a natural number, and the micromirrors are vertically arranged in the optical modulator 120. In this case, the optical modulator 130 can output a modulation beam, which is modulated with an incident beam loaded with information related to a linear image corresponding to a vertical scanning line. As the time passes, the modulation beams can be vertically scanned by a scanner, to thereby display an image.

If the time is required to be output one display image is assumed to be Td, the time of outputting one modulation beam Tm can equal to td/m (i.e. Tm=Td/m).

In the present invention, it is one of good examples that the time for equalization is the foregoing Tm in order to have a uniform beam by using a light homogenizing device. In particular, it is one of good examples that the time proceeding from T0 to T3 or from T3 to T0 is equal to or smaller than Tm. This is because the variations of each beam can be uniformly equalized by allowing the beams having various areas to be incident within the period of time Tm, which it takes for each micromirror of the optical modulator to represent one pixel.

Accordingly, the present invention can equalize the variation of light in an illumination system by using a light homogenizing device. This makes it unnecessary to correct the variation of light, to thereby reduce an initial correcting step of the optical modulator.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A light homogenizing device, comprising:
a light source;
a polarization rotator, including two planes of polarization that are orthogonal to each other, and receiving a beam of light incident from the light source and outputting a polarized linear beam of light; and
a birefringent plate, receiving the polarized linear beam of light and outputting refracted beam of light proceeding by being shifted on different distance depended on the polarization of incident beam.
whereas the two refracted beams of light are combined in time at a predetermined point into a uniform beam of light.

2. The device of claim 1, wherein the polarization rotator is a liquid crystal polarization rotator, and the liquid crystal polarization rotator outputs the polarized linear beam of light with variable plane of polarization by changing an optical-active characteristic according to a supplied power.

3. The device of claim 1, wherein the uniform beam of light has a double intensity as much as any one of the refracted beams of light, and a standard deviation of the intensity of uniform beam of light is a square root of a sum of square of standard deviation of every refracted beam of light.

4. The device of claim 1, wherein the birefringent plate leans to a forwarding direction of the beam of light incident on the birefringent plate at a predetermined angle.

5. The device of claim 1, wherein the two refracted beams of light have different proceeding speeds, respectively, and the two refracted beams of light are combined at a predetermined point within a predetermined interval of time.

6. A display apparatus, comprising:
a light source;
an active polarization rotator, including two planes of polarization that are orthogonal to each other, and receiving a beam of light incident from the light source and outputting a polarized linear beam of light;
a birefringent plate, receiving the polarized linear beam of light and outputting two refracted beams of light proceeding by being refracted in different directions,
a one-dimensional optical modulator, arranged at a point on which the two refracted beams of light are combined into a predetermined point, and receiving the uniform beam of light and outputting a modulation beam of light; and
a scanner, successively scanning the modulation beam of light on a display screen.

7. The apparatus of claim 6, wherein the polarization rotator is a liquid crystal polarization rotator, and the liquid crystal polarization rotator outputs the polarized linear beam of light with variable plane of polarization by changing an optical-active characteristic according to a supplied power

8. The apparatus of claim 6, wherein the uniform beam of light has a double intensity as much as any one of the refracted beams of light, and a standard deviation of the uniform beam of light is a square root of a sum of a square of standard deviation of each refracted beam of light.

9. The apparatus of claim 6, wherein the birefringent plate leans to a forwarding direction of the beam of light incident on the birefringent plate at a predetermined angle.

10. The apparatus of claim 6, wherein the two refracted beams of light have different proceeding speeds, respectively, and the two refracted beams of light are combined at a predetermined point within a predetermined interval of time.

11. The apparatus of claim 10, wherein, if the modulation beam of light is successively scanned to form a two-dimensional image, the predetermined interval of time is a same as or smaller than an interval of time it takes for a frame to be formed.

12. The apparatus of claim 6, wherein the modulation beam of light is successively scanned on a screen to form a two-dimensional image.

13. The apparatus of claim 6, wherein a period of the uniform beam of light corresponds to the size and number of micromirrors arranged in a lengthwise direction of the one-dimensional optical modulator.

14. A display apparatus, comprising:
a light source;
a light homogenizing device, repeatedly changing a proceeding path of a basic beam of light emitted from the light source according to a change of time;
an optical modulator, receiving the beam having the changed proceeding path and modulating the received beam of light to output a modulation beam of light;
a scanner, scanning the modulation beam of light outputted from the optical modulator on a screen; and
an image processing unit, receiving an image signal and generating and outputting a control signal for controlling the light source, the optical modulator and the scanner according to the image signal.

15. The display apparatus of claim 14, wherein the optical modulator is a linear optical modulator in which a plurality of micromirrors are arranged in a line.

16. The display apparatus of claim 14, wherein a sectional surface of the basic beam comprises all incident surfaces of the optical modulator.

17. The display apparatus of claim 16, wherein the light homogenizing device allows one end part of a sectional surface of the basic beam to be in contact with one end part of the optical modulator at a first point of time and the other end part of a sectional surface of the basic beam to be in contact with the other end part of the optical modulator at a second point of time.

18. The display apparatus of claim 17, wherein the light homogenizing device changes a proceeding path of the basic beam of light in a range between a proceeding path of the first point of time and a proceeding path of the second point of time.

19. The display apparatus of claim 17, wherein the light homogenizing device changes a proceeding path of the basic beam proceeding from the first point of time to the second point of time or from the second point of time to the first point of time within a period of time that it takes for the optical modulator to output a modulation beam corresponding to one linear image.

20. The display apparatus of claim 14, wherein the light homogenizing device is made of an electro-optical material.

21. The display apparatus of claim 14, wherein the light homogenizing device comprises a light transmissive unit and a vibrator, connected to one end part of the light transmissive unit and vibrating the light transmissive unit.
